(19) United States
(12) Patent Application Publication
(10) Pub. No.: US 2009/0259782 A1
(43) Pub. Date: Oct. 15, 2009

(54) APPARATUS AND METHOD FOR AUTOMATICALLY PERFORMING SYSTEM CONFIGURATION

(75) Inventors: Zigui Luo, Shanghai City (CN); Chih-Feng Chen, Taipei City (TW)

Correspondence Address: J C PATENTS, 4 VENTURE, SUITE 250, IRVINE, CA, 92618, US

(73) Assignee: INVENTEC CORPORATION, Taipei City (TW)

(21) Appl. No.: 12/121,365

(22) Filed: May 15, 2008

(30) Foreign Application Priority Data
Apr. 10, 2008 (TW) 97113031

(51) Int. Cl. G06F 13/00

(52) U.S. Cl. 710/104

(57) ABSTRACT

An apparatus and a method for automatically performing system configuration are provided. The apparatus includes a motherboard and a peripheral backplane. The motherboard includes a data transmission interface and has a plurality of predetermined messages, and the peripheral backplane includes a sensor. The motherboard is coupled to the peripheral backplane through the data transmission interface. The sensor disposed on the peripheral backplane identifies the type of a system in which the apparatus is applied and generates an identification code corresponding to the system type. The motherboard then selects one of the predetermined messages as a configuration message according to the identification code and automatically performs system configuration to peripheral devices by using the configuration message.

### CROSS-REFERENCE TO RELATED APPLICATION

This application claims the priority benefit of Taiwan application serial no. 97113031, filed on Apr. 10, 2008. The entirety of the above-mentioned patent application is hereby incorporated by reference herein and made a part of specification.

### BACKGROUND OF THE INVENTION

1. Field of the Invention

The present invention generally relates to an apparatus and a method, in particular, to an apparatus and a method for automatically performing system configuration.

2. Description of Related Art

Nowadays, servers are broadly adopted by various enterprises. Besides being applied in internet and telecommunication applications, servers are also broadly applied in our daily life, such as in finance, economics, e-banking, and credit card application over the Internet etc. All these applications rely greatly on the powerful calculation capability of servers in order to ensure that data is highly secured and difficult to be cracked.

Generally speaking, there are many different types of servers, wherein rack server and tower server are the most commonly adopted two. Rack servers are usually grouped into 1U, 2U, and 4U systems, and tower servers are usually grouped into 5U and 6U systems. A motherboard of a server is usually designed to be compatible to different types (for example, 1U, 2U, and 5U) of systems in order to enlarge the application range of the motherboard.

In order to allow a motherboard in a server to be compatible to various types of systems, the server has to be able to identify the type of the system it is applied in and perform different system configuration accordingly. Conventionally, the system manufacturer has to update the sensor data record whenever the system type (chassis) of the server is changed. The system manufacturer has to update the sensor data record through manual identification and operation to write the related information on the chassis into a baseboard management controller.

In other words, the conventional technique is to update the sensor data record in the baseboard management controller through manual identification and operation and accordingly identify the system type of the server and the corresponding information thereof. However, the conventional method is very inconvenient and error-prone, and the flexibility in the application of the server is reduced.

### SUMMARY OF THE INVENTION

Accordingly, the present invention is directed to an apparatus for automatically performing system configuration, wherein system configuration can be automatically performed through no manual identification or operation.

The present invention is directed to a method for automatically performing system configuration, wherein an identification code corresponding to the system type is generated by using a sensor disposed on a peripheral backplane such that a motherboard can automatically perform system configuration by using only the identification code.

The present invention provides an apparatus for automatically performing system configuration, wherein the apparatus identifies the type of system it is applied in and performs the system configuration automatically. The apparatus includes a motherboard and a peripheral backplane. The motherboard includes a data transmission interface and has a plurality of predetermined messages. The motherboard is coupled to the peripheral backplane through the data transmission interface, and the predetermined messages are information required by the motherboard for performing various system configurations.

On the other hand, the peripheral backplane includes a sensor. The sensor determines the type of the system in which the apparatus is applied and generates an identification code corresponding to the system type. Accordingly, the motherboard can select one of the predetermined messages as a configuration message according to the identification code and performs system configuration to peripheral devices by using the configuration message.

According to an embodiment of the present invention, the motherboard further includes a sensor data record unit, a match unit, and a baseboard management controller. The sensor data record unit provides the predetermined messages, wherein the predetermined messages are respectively corresponding to a predetermined code. The match unit respectively compares the identification code with the predetermined codes corresponding to the predetermined messages so as to select one of the predetermined messages as the configuration message. Accordingly, the baseboard management controller can read and store the configuration message so as to achieve a real-time control over the entire system.

According to an embodiment of the present invention, each of the predetermined messages includes a chassis type information, a fan number information, a backplane information, an riser card information, and a power supply information. In addition, the system is a rack system or a tower system, and the peripheral backplane is a hard disk backplane.

The present invention also provides a method for automatically performing system configuration, wherein the type of a system in which an apparatus is applied is identified and the system configuration is automatically performed. The apparatus includes a motherboard and a peripheral backplane, and the motherboard includes a data transmission interface. The peripheral backplane is coupled to the motherboard through the data transmission interface.

The method for automatically performing system configuration includes following steps. First, a plurality of predetermined messages are set on the motherboard. Then, a sensor is disposed on a peripheral backplane which conforms to the type of the system in which the apparatus is applied, and an identification code corresponding to the system type is generated by using the sensor. Accordingly, the motherboard can select one of the predetermined messages as the configuration message according to the identification code and perform system configuration to peripheral devices by using the configuration message.

As described above, in the present invention, a sensor is disposed on a peripheral backplane such that the motherboard can use the sensor to generate an identification code and accordingly identify the type of a system in which the apparatus is applied. Accordingly, the motherboard can determine a configuration message among a plurality of predetermined messages according to the identification code and perform system configuration to peripheral devices automatically. Compared to the conventional technique, the present invention provides an apparatus which can automatically perform system configuration corresponding to different system type through no manual identification or operation. Thereby, mistakes in manual identification and operation can be avoided and the flexibility in the application of the apparatus can be improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an apparatus for automatically performing system configuration according to an embodiment of the present invention.

FIG. 2 is a flowchart of a method for automatically performing system configuration according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

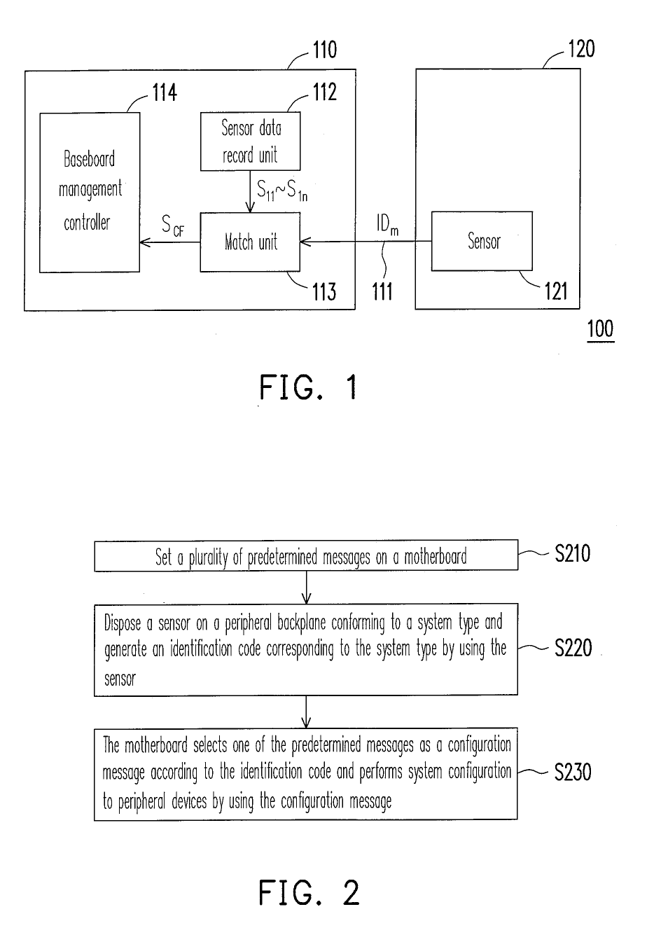

FIG. 1 is a block diagram of an apparatus for automatically performing system configuration according to an embodiment of the present invention. Referring to FIG. 1, in the present embodiment, the apparatus 100 can identify the type of a system in which it is applied so as to perform system configuration automatically.

Referring to FIG. 1 again, the apparatus 100 includes a motherboard 110 and a peripheral backplane 120. The motherboard 110 is used for assembling other backplanes. For example, if the motherboard 110 is compatible to 1U rack servers or 2U rack servers in actual application, the motherboard 110 can be electrically connected to a 1U rack backplane or a 2U rack backplane selectively. However, it should be understood by those skilled in the art that the present invention is not limited to foregoing assumptions, and a server may be a rack system or a tower system and the present embodiment may also be applied in other computer systems.

The motherboard 110 performs different system configuration corresponding to a server having different system type. In order to allow the motherboard 110 to automatically identifies the type of a system in which it is applied, the motherboard 110 includes a data transmission interface 111 and has a plurality of predetermined messages S₁₁˜S₁ₙ. The motherboard 110 is electrically connected to the peripheral backplane 120 conforming to the system type through the data transmission interface 111. In the present embodiment, the peripheral backplane 120 may be a hard disk backplane.

Additionally, the predetermined messages S₁₁˜S₁ₙ contain various information required by the motherboard 110 for performing various system configurations. For example, the predetermined message S₁₁ contains a chassis type information, a fan number information, a backplane information, a riser card information, and a power supply information of an 1U rack system, the predetermined message S₁₂ contains a chassis type information, a fan number information, a backplane information, a riser card information, and a power supply information of a 2U rack system, and so on.

On the other hand, a sensor 121 is disposed on the peripheral backplane 120. The sensor 121 determines the type of the system in which the peripheral backplane 120, namely, the apparatus 100 is applied, and generates an identification code IDₘ corresponding to the system type. Accordingly, the motherboard 110 can select one of the predetermined messages S₁₁˜S₁ₙ as a configuration message S_{CF} according to the identification code IDₘ from the sensor 121 and perform system configuration to peripheral devices by using the configuration message S_{CF}.

For example, if the peripheral backplane 120 is a 1U rack backplane, the sensor 121 generates an identification code ID₁ corresponding to 1U rack system. Accordingly, the motherboard 110 selects the predetermined message S₁₁ which is corresponding to 1U rack system as the configuration message S_{CF} according to the identification code ID₁. Moreover, the configuration message S_{CF} (the predetermined message S₁₁) contains the chassis type information, the fan number information, the backplane information, the riser card information, and the power supply information of a 1U rack system. Thus, the motherboard 110 can perform system configuration to 1U rack peripheral devices according to the configuration message S_{CF}.

If the peripheral backplane 120 is a 2U rack backplane, the sensor 121 generates an identification code ID₂ corresponding to 2U rack system. Accordingly, the motherboard 110 selects the predetermined message S₁₂ corresponding to 2U rack system as the configuration message S_{CF} according to the identification code ID₂. Moreover, the configuration message S_{CF} (the predetermined message S₁₂) contains the chassis type information, the fan number information, the backplane information, the riser card information, and the power supply information of a 2U rack system. Thus, the motherboard 110 can perform system configuration to 2U rack peripheral devices according to the configuration message S_{CF}.

It should be noted that in the present embodiment, the motherboard 110 can determine the type of the system in which it is applied by using the identification code IDₘ received from the sensor 121. Accordingly, the motherboard 110 can automatically select the configuration message S_{CF} from the predetermined messages S₁₁˜S₁ₙ and automatically perform system configuration accordingly. In other words, the motherboard 110 can perform system configuration corresponding to different system type through no manual identification or operation, so that mistakes in manual identification and operation can be avoided and the flexibility in the application of a server can be improved.

In order to allow those skilled in the art to better understand the present invention, the motherboard 110 will be further described below. Referring to FIG. 1 again, the motherboard 110 further includes a sensor data record unit 112, a match unit 113, and a baseboard management controller 114. The sensor data record unit 112 and the baseboard management controller 114 are respectively coupled to the match unit 113, and the match unit 113 is coupled to the sensor 121 through the data transmission interface 111.

The sensor data record unit 112 is used for providing the predetermined messages S₁₁˜S₁ₙ, wherein the predetermined messages S₁₁˜S₁ₙ are respectively corresponding to one predetermined code. The match unit 113 compares the identification code IDₘ respectively with the predetermined codes corresponding to the predetermined messages S₁₁˜S₁ₙ so as to select one of the predetermined messages S₁₁˜S₁ₙ as the configuration message S_{CF}. On the other hand, the baseboard management controller 114 reads and stores the configuration message S_{CF} so as to achieve a real-time control over the entire system.

FIG. 2 is a flowchart of a method for automatically performing system configuration according to an embodiment of the present invention. The method in the present embodiment is to identify the type of system in which an apparatus is applied so as to perform system configuration automatically. The apparatus includes a motherboard and a peripheral backplane, wherein the motherboard includes a data transmission interface, and the peripheral backplane is coupled to the motherboard data transmission interface.

Referring to FIG. 2, first, in step S210, a plurality of predetermined messages are set on the motherboard. Next, in step S220, a sensor is disposed on a peripheral backplane which conforms to the type of the system in which the apparatus is applied, and an identification code corresponding to the system type is generated by using the sensor. Then in step S230, the motherboard selects one of the predetermined messages as a configuration message according to the identification code and performs system configuration to peripheral devices by using the configuration message. The detailed procedure of the present embodiment has been described in the embodiment illustrated in FIG. 1 therefore will not be described herein.

In overview, according to the present invention, a sensor is disposed on a peripheral backplane such that a motherboard can identify the type of a system in which an apparatus is applied by using an identification code generated by the sensor. Thus, the motherboard can select a configuration message from a plurality of predetermined messages according to the identification code and accordingly perform system configuration to peripheral devices automatically. Since in the present invention, the apparatus can automatically perform system configuration corresponding to different system type through no manual identification or operation, mistakes in manual identification and operation can be avoided and the flexibility in the application of a server can be effectively improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for automatically performing system configuration, wherein the apparatus identifies the type of a system in which the apparatus is applied and automatically performs system configuration accordingly, the apparatus comprising:
a motherboard, comprising a data transmission interface and having a plurality of predetermined messages, wherein the motherboard is used for assembling other backplanes; and
a peripheral backplane, coupled to the motherboard through the data transmission interface, wherein the peripheral backplane conforms to the type of the system and comprises:
a sensor, for determining the type of the system and generating an identification code corresponding to the type of the system,
wherein the motherboard selects one of the predetermined messages as a configuration message according to the identification code and performs system configuration to peripheral devices by using the configuration message.

2. The apparatus according to claim 1, wherein the motherboard further comprises:
a sensor data record unit, for providing the predetermined messages, wherein the predetermined messages are respectively corresponding to one predetermined code.

3. The apparatus according to claim 2, wherein the motherboard further comprises:
a match unit, coupled to the sensor data record unit, and coupled to the sensor through the data transmission interface, wherein the match unit compares the identification code respectively to the predetermined codes corresponding to the predetermined messages so as to select one of the predetermined messages as the configuration message.

4. The apparatus according to claim 3, wherein the motherboard further comprises:
a baseboard management controller, coupled to the match unit for reading and storing the configuration message.

5. The apparatus according to claim 2, wherein each of the predetermined messages comprises a chassis type information, a fan number information, a backplane information, a riser card information, and a power supply information.

6. The apparatus according to claim 1, wherein the system is a rack type system or a tower type system.

7. The apparatus according to claim 1, wherein the peripheral backplane is a hard disk backplane.

8. A method for automatically performing system configuration, wherein the method is to identify the type of a system in which an apparatus is applied so as to perform system configuration automatically, the apparatus comprises a motherboard and a peripheral backplane, the motherboard comprises a data transmission interface, and the peripheral backplane is coupled to the motherboard through the data transmission interface, the method comprising:
setting a plurality of predetermined messages on the motherboard;
disposing a sensor on the peripheral backplane conforming to the type of the system, and generating an identification code corresponding to the type of the system by using the sensor; and
selecting one of the predetermined messages as a configuration message according to the identification code by using the motherboard, and performing system configuration to peripheral devices by using the configuration message.

9. The method according to claim 8, wherein the predetermined messages are respectively corresponding to one predetermined code.

10. The method according to claim 9, wherein the step of selecting one of the predetermined messages as the configuration message according to the identification code by using the motherboard comprises:
comparing the identification code respectively with the predetermined codes corresponding to the predetermined messages.

11. The method according to claim 8, wherein the step of performing system configuration to peripheral devices by using the configuration message comprises:
reading and storing the configuration message by using a baseboard management controller of the motherboard.

12. The method according to claim 8, wherein each of the predetermined messages comprises a chassis type information, a fan number information, a backplane information, a riser card information, and a power supply information.

13. The method according to claim 8, wherein the system is a rack type system or a tower type system.

14. The method according to claim 8, wherein the peripheral backplane is a hard disk backplane.
